(19) United States
(12) Patent Application Publication
(10) Pub. No.: US 2004/0213886 A1
(43) Pub. Date: Oct. 28, 2004

(54) Soy-based fruit and/or vegetable food product and processes for making same

(76) Inventor: Frances Ann Toves, Reno, NV (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/422,606

(22) Filed: Apr. 23, 2003

(51) Int. Cl. A23L 1/36

(52) U.S. Cl. 426/629

(57) ABSTRACT

A soy-based, reduced-calorie fruit and/or vegetable food product including whole, natural fruit(s) and/or vegetable(s), or combinations thereof, having improved flavor, texture (e.g., mouth feel), color, and nutritional value as compared to fruit and/or vegetable spread products made with conventional processes, and processes for making, or preparing, same. More particularly, the processes of the present invention includes a pasteurization step, using a swept-surface heat exchanger, for making soy-based fruit and/or vegetable food products having reduced caloric and sugar content and having increased soluble dietary fiber content. The minimal processing of the present processes enables the produced soy-based fruit and/or vegetable food products to retain flavor, texture, mouth feel, color, vitamins and other nutrients which are, typically, lost in traditionally-processed fruit and/or vegetable food products. The process' preferable use of squeeze tube packaging eliminates the need for cutlery in order to use or consume the soy-based fruit and/or vegetable food products and serves to make the products more portable.

### FIELD OF THE INVENTION

The present invention relates, generally, to the field of reduced-calorie fruit and vegetable food products and, in its preferred embodiments, to a soy-based, reduced-calorie, whole-fruit and/or vegetable food product optionally fortified with dietary fiber and/or vitamins and/or minerals or other nutrients, and processes for making same.

### BACKGROUND OF THE INVENTION

Many individuals apply fruit or vegetable spreads, such as jams, jellies, purees and preserves, to other food products in order to enhance the flavor and nutritional value of the other food products with the taste and nutritional content of the fruit or vegetable spreads. Such fruit or vegetable spreads, generally, include a fruit or vegetable ingredient and a saccharide ingredient, but may also contain nutritive carbohydrate sweeteners, spice, acidifying agents, pectin (i.e., in an amount sufficient to compensate for natural deficiencies in fruits or vegetables), buffering and antifoaming agents, preservatives, and other ingredients or agents for improving or preserving their taste, nutritional value, and quality. The saccharide ingredient in jams, jellies and preserves is typically sugar, which provides sweetening, bulk, texture, and mouth feel. The sugar also reduces the water activity level, thereby reducing pathogen growth.

In an attempt to achieve a healthier lifestyle, many individuals have incorporated more protein and other nutrients into their diets. The World Health Organization has established that soy protein contains enough of all the essential amino acids to meet human requirements when consumed at the recommended level of protein intake. As a result, consumers are seeking ways to incorporate more soy-based foods into their diets. In addition to the nutritional benefits of soy-based products, consumers are satisfied that soy products are natural, a healthy alternative to the processed animal fats and chemical preservatives found in mass-produced food products.

Typically, the preparation of jams, jellies, purees and preserves comprises a number of steps. Initially, fruit ingredients in a pulverized or pureed form, sweeteners and water are blended together. A stabilizing solution, such as pectin, is then prepared and added to the fruit, sweetener, and water blend to produce a mixture. During subsequent vat cooking of the mixture, unwanted water is evaporated to create a cooked mixture having desired soluble solids content. Finally, the cooked mixture is placed in suitable receptacles, such as jars, through a hot-filling process. Unfortunately, the steps of vat cooking and evaporation cause the fruit spread to lose flavor intensity (i.e., through boiling-off), texture and mouth feel (i.e., through breakdown of the fruit fibers into mush), natural color (i.e., through darkening or oxidation), and nutrients (i.e., through boiling-off).

Various inventors have attempted to resolve the above-described problems, deficiencies or difficulties with fruit spreads and the manufacture thereof. For instance, one inventor developed a process for evaporating the water from a fruit-based product while attempting to preserve flavor. The process includes removing portions of fruit and glucose syrup from a mixture of these components with sugar. The removed portions and the remaining mixture are then separately boiled to evaporate the water from each. The removed portions are boiled in an open vat, while the remaining mixture is boiled in a closed cooking vat. After recombining the boiled mixtures, the product is pasteurized and packaged, but evaporation of the excess water results in flavor loss.

Other inventors and manufacturers, in response to studies indicating that excessive amounts of sugar in food products may contribute to or exacerbate many health problems and to the resultant desire among consumers for low-sugar fruit spreads, have attempted to enhance the healthiness of fruit spreads by employing sugar substitutes to produce low-calorie, low-sugar products. However, as described below, such sugar substitutes and processes for making fruit spreads which incorporate them, tend to create fruit spreads having various difficulties, including deficiencies in sensory (sweetness intensity, quality and flavor), visual (color, clarity and gloss), and textural (firmness, body, mouth feel, and spreadability) properties as compared to their naturally sweetened counterparts. One inventor, attempting to resolve such deficiencies, incorporated a multi-component gum system to impart desirable textural properties to pectin or carrageenan gel, but utilized the conventional method of fruit spread preparation described above and, as a result of the vat cooking step, produced a fruit spread deficient in flavor.

In a somewhat different approach to improving the texture of low-calorie fruit spreads another inventor incorporated a fat replacement ingredient into a fruit spread rather than using a reduced-calorie sweetener. By using the fat replacement as an additive in a generally fat-free food, the inventor was able to simulate the texture and lubricity of fat in a fruit spread product. However, the fruit spread required the creation of a microparticulated mixture which destroyed the natural texture of the spread's fruit. Also, unfortunately, use of the fat replacement ingredient actually resulted in a higher calorie product, while cooking of the mixture caused the loss of some of the natural flavor of the spread's fruit.

Still other inventors and manufacturers have attempted to produce jams, jellies and other fruit-based products with a reduced caloric content by substituting oligofructose and/or inulin in place of some of the sugar, while taking advantage of the known bulking properties of such fructans. Unfortunately, because the above-described cooking process for producing jams and jellies tends to degrade the oligofructose and/or inulin at high temperatures and low pH, and because the shelf-life of products containing oligofructose may be inadequate, these attempts have proven difficult.

In an attempt to extend the shelf-life of products containing oligofructose, pasteurization processes have been used, even though it is known that the pasteurization conditions may cause the oligofructose to degrade and, hence, be detrimental to the quality of the products. One inventor addressed the difficulties associated with the pasteurization of products made with oligofructoses and sets forth specific conditions (i.e., the oligofructoses are heated in a very narrow range of temperature from 72 degrees to 82 degrees Celsius for a period of 10 to 300 seconds) for the successful pasteurization of such products. However, the inventor noted that the texture of inulin is destroyed at temperatures higher than 82 degrees Celsius.

Inulin is also used in dairy products sweetened with high-intensity sweeteners. Because inulin has been shown to increase the absorption of calcium in adolescent girls who consume at least 8 grams of inulin per day, incorporation of inulin into dairy products is becoming more common and more desirable. For example, Stonyfield Farm, a New Hampshire manufacturer, markets a full line of soy yogurts and soy smoothies prepared with inulin and other dietary fibers.

Some inventors have attempted to incorporate soy protein and nutrients into other fiber-containing food products. For example, one inventor has described a yogurt having soy-fortified fruit flavoring. By combining soy fiber, sugar, dietary fiber and fruit, and then cooking the mixture to a point just below the boiling point of the mixture, a fruit filling which can be combined with a yogurt base was produced. The process, however, requires that the fruit be cooked for about 30 minutes, destroying the textural quality of the fruit and, presumably, the dietary fiber.

Finally, still other inventors and manufacturers have attempted to resolve the, as yet undiscussed, problem of microbiological contamination which may occur during the preparation of fruit spreads. To reduce the likelihood of microbiological contamination, one inventor determined that a water-based jelly product having whole fruit pieces may be hot-filled into appropriate receptacles following a pasteurization process to kill off microbes. The inventor noted that microbiological contamination may be overcome by hot-filling receptacles at a temperature above 70 degrees Celsius. According to the inventor, the form of the water-based jelly may be maintained during the heating process by the addition of a thickener, xanthan, and a gelling agent, including inulin, to the water-based jelly. After pasteurization of the water-based jelly, whole fruit is injected into the pasteurized jelly product just prior to hot-filling. Unfortunately, because the fruit must be stable against processing stress, certain varieties, especially berry varieties, of fruit cannot be used in fruit spread products made with the inventor's process. Moreover, fruit spread products made with the process have, or tend to have, a texture similar to that of gelatin desserts (e.g., JELL-O®), which are very watery and not suitable for spreading, for instance, on toast. Further, even at refrigerated temperatures, fruit spread products prepared using the inventor's process have an extremely short shelf-life.

Therefore, there exists in the industry, a need for a process for making a soy-based, reduced-calorie, natural, whole-fruit and/or vegetable spread with an adequate shelf-life which does not diminish the natural flavor, texture, mouth feel, color, or nutritional content of the fruit(s) and/or vegetable(s) therein, and for addressing these and other related, and unrelated, problems.

### SUMMARY OF THE INVENTION

Briefly described, the present invention comprises a soy-based, reduced-calorie fruit and/or vegetable spread product including whole, natural fruit(s) and/or vegetable(s), or combinations thereof and processes for making, or preparing, same. The present invention further comprises a soy-based, reduced-calorie fruit and/or vegetable spread product including whole, natural fruit(s) and/or vegetable(s), or combinations thereof having reduced caloric and sugar content and having increased soluble dietary fiber content which may optionally be fortified with additional nutrients. The soy-based, fruit and/or vegetable product may, for example and without limitation, be provided to consumers as jams, jellies, preserves, purees, marmalades, beverages, snacks, pie fillings, puddings, and used as bases for: fruit-flavored drinks and/or beverages, such as “smoothies,” ice cream toppings, condiments, fruit toppings, yogurts, dressings, baby food, curd, cheeses, dips, and sauces. The present invention further comprises processes, including a pasteurization step, for making such a soy-based fruit and/or vegetable product. Importantly, the processes produce a soy-based fruit and/or vegetable food product without the discoloration and the reductions in flavor, texture, mouth feel and nutrients (including, without limitation, vitamins and/or minerals) that occur with fruit or vegetable food products made with conventional processes which include a cooking and/or evaporation step. The soy-based fruit and/or vegetable food products produced by the processes of the present invention provide: spreads, desserts, frozen novelties and puddings having flavor approaching that of fresh fruits (or vegetables); texture and mouth feel superior to that of traditionally-prepared fruit and/or vegetable food products; and reduced caloric content as compared to traditionally-prepared fruit or vegetable products.

The processes of the present invention avoid the flavor, texture, mouth feel, and nutrient losses that occur during conventional processing of fruit and/or vegetable food products by using a high-temperature short-time (HTST) pasteurization process instead of the traditional vat cooking and evaporation processes. By combining tofu or soy puree, whole fruit(s), vegetable(s), or a combination thereof with a homogenized slurry of other ingredients, including at least (i) sweetener, such as, for example and not limitation, fruit juice concentrate, invert syrup, corn syrup, high fructose corn syrups, maltose, cane syrup, honey, polyols such as sorbitol, mannitol, glycerol, propylene glycol, fruit juices or any mixtures thereof, and, (ii) soluble dietary fiber such as, for example and not limitation, fructo-oligosaccharide or inulin, (iii) pectin, and (iv) optionally, other nutrients, including, without limitation, vitamins and/or minerals, and by then pasteurizing the combined mixture in, preferably, a swept-surface heat exchanger, a shelf-stable fruit and/or vegetable product having less sugar (and, hence, reduce caloric content) and more protein and dietary fiber is produced. The resulting soy-based fruit and/or vegetable products have good textural quality, and mouth feel, intense flavor, and, in the case of jams or jellies, maintain the color and structural integrity of the whole fruit(s) and/or vegetable(s) present therein.

The soy-based fruit and/or vegetable food products of the present invention may contain additional ingredients including, for example and without limitation, starches, oils, flavorings, colors, and/or live cultures. The products may have a smooth creamy consistency, such as for example and without limitation, the consistency found in yogurts, sorbets, margarines, puddings, and gelatos, or it may be of a firmer consistency, such as that of cream cheese or as that of a stick or tub of margarine or butter. The soy-based fruit and/or vegetable product of the present invention may contain fruit chunks, bits or pieces, or it may be of a substantially homogeneous creamy form. The soy-based fruit and/or vegetable products of the present invention may be incorporated into, combined with, or spread onto other foods such as, for example and without limitation, yogurt, sorbet, margarine, pudding, gelato, cream cheese, bread, crackers, cookies, icing, ice cream, milk shakes, smoothies, dressings, baby food and the like. They may also be formed into various forms such as, for example and not limitation, popsicles, frozen novelties, stick forms, or tub forms.

According to the preferred embodiments described herein, the processes of the present invention use less sugar than is used in traditional fruit and/or vegetable food product processing. Such reduction of the sugar content lowers the incidence of discoloration in the resulting fruit and/or vegetable products (i.e., as compared to the discoloration which occurs in traditionally, or conventionally, prepared fruit and/or vegetable products) which occurs as a consequence of non-enzymatic browning (also referred to as “Maillard Browning”). The process' use of less sugar also results in higher water activity levels during preparation that are more amenable to pasteurization, thereby enhancing the pasteurization process.

Because the processes of the present invention utilize whole fruit(s) and/or vegetable(s) and/or combinations thereof in lieu of fruit or vegetable juices for flavoring, the resulting soy-based fruit and/or vegetable food products have improved taste, texture, and mouth feel when compared to fruit and/or vegetable food products traditionally made with such fruit or vegetable juices. By using pasteurization for microkill instead of cooking as in conventional fruit and/or vegetable food product processing, the processes of the present invention do not “cook down” whole fruit(s) and/or vegetable(s) into mush and does not destroy their structural integrity, and thereby enhances the texture and mouth feel of the resulting fruit and/or vegetable food products. Also, by using pasteurization instead of vat cooking, the vitamins and other nutrients of the whole fruit(s) and/or vegetable(s) are not lost by the present processes to the same extent that they are lost by the evaporation of vapor during the vat cooking step of conventional processing.

The processes of the present invention additionally produce fruit and/or vegetable food products that may naturally fortify a consumer's gastrointestinal tract. More particularly, the addition of dietary fiber (i.e., in the preferable form of inulin) by the processes to the fruit and/or vegetable food products produced thereby, may cause increased absorption of nutrients in the consumer's gastrointestinal tract, thus providing a natural health food.

The soy-based fruit and/or vegetable food products of the present invention provide the added nutritional benefits of soy and soy protein. The World Health Organization has established that soy protein contains enough of all the essential amino acids to meet human requirements when consumed at the recommended level of protein intake. Soy proteins are considered equivalents to animal proteins in quality, yet they do not contain the unhealthy fats found in animal proteins. Additionally, soybeans, the source of soy proteins, are high in iron, calcium and zinc. Soy foods are generally good sources of the B vitamins, especially thiamin, B6 and folate, and Vitamin E, making fortification of these vitamins and minerals unnecessary.

In addition to the previously described benefits of the present invention's use of high-temperature short-time (HTST) pasteurization, such pasteurization contributes to increasing the shelf stability of the soy-based fruit and/or vegetable products made by the processes. The shelf stability of the resulting soy-based fruit and/or vegetable products is further enhanced by the heating and packaging steps of the processes, which are conducted under substantially closed conditions to aid in eliminating the possibility of product contamination and to reduce product oxidation (and, hence, discoloration). Notably, the results of testing on soy-based fruit and/or vegetable spread products prepared by the processes of the present invention seem to indicate that the shelf-life of such products is significantly longer than traditionally-prepared soy products.

Further, the processes of the present invention enable packaging of soy-based fruit and/or vegetable products made thereby, preferably, in squeezable tubes. Such packaging tends to keep the fruit and/or vegetable food products hygienically safe and substantially free from contaminants and discoloration due to oxidation of the fruit(s) and/or vegetable(s) therein (i.e., due to reduced exposure to air) during repeated use. Such packaging also eliminates the need for cutlery in order to use or consume the fruit and/or vegetable food products and serves to make the products more portable.

It is therefore an object of the present invention to make a soy-based, reduced-calorie, natural, whole-fruit and/or vegetable food product which suffers less reduction of the natural flavor of the fruit(s) and/or vegetable(s) therein during processing than fruit and/or vegetable food products made with conventional processes.

Another object of the present invention is to make a soy-based, reduced-calorie, natural, whole-fruit and/or vegetable product which suffers less loss of the texture and mouth feel of the fruit(s) and/or vegetable(s) therein during processing than fruit and/or vegetable food products made with conventional processes.

Still another object of the present invention is to make a soy-based, reduced-calorie, natural, whole-fruit and/or vegetable food product which suffers less discoloration of the fruit(s) and/or vegetable(s) therein during processing than fruit and/or vegetable food products made with conventional processes.

Still another object of the present invention is to make a soy-based, reduced-calorie, natural, whole-fruit and/or vegetable food product which suffers less loss of the nutritional content of the fruit(s) and/or vegetable(s) therein during processing than fruit and/or vegetable food products made with conventional processes.

Still another object of the present invention is to make a reduced-calorie, natural, whole-fruit and/or vegetable food product having better flavor than fruit and/or vegetable food products made with conventional processes.

Still another object of the present invention is to make a natural, whole-fruit and/or vegetable food product having fewer calories than fruit and/or vegetable food products made with conventional processes.

Still another object of the present invention is to make a soy-based, reduced-calorie, natural, whole-fruit and/or vegetable food product having less sugar than fruit and/or vegetable food products made with conventional processes.

Still another object of the present invention is to make a soy-based, reduced-calorie, natural, whole-fruit and/or vegetable food product having more dietary fiber than fruit and/or vegetable food products made with conventional processes.

Still another object of the present invention is to make a soy-based, reduced-calorie, natural, whole-fruit and/or vegetable food product having more dietary protein than fruit and/or vegetable food products made with conventional processes.

Still another object of the present invention is to make a soy-based, reduced-calorie, natural, whole-fruit and/or vegetable food product incorporating soluble dietary fiber, or fortified soluble dietary fiber, into a fruit and/or vegetable food product without adversely affecting the texture, mouth feel, and/or color of the product.

Still another object of the present invention is to make a soy-based, reduced-calorie, natural, whole-fruit and/or vegetable food product having better texture and/or mouth feel than fruit and/or vegetable foods made with conventional processes.

Still another object of the present invention is to make a soy-based, reduced-calorie, natural, whole-fruit and/or vegetable food product having more natural color than fruit and/or vegetable foods made with conventional processes.

Still another object of the present invention is to make a soy-based, reduced-calorie, natural, whole-fruit and/or vegetable food product having better nutritional content, or value, than fruit and/or vegetable foods made with conventional processes.

Still another object of the present invention is to make a soy-based, reduced-calorie, natural, whole-fruit and/or vegetable food product having shelf stability at least comparable to that of fruit and/or vegetable products made with conventional processes.

Other objects, features, and advantages of the present invention will become apparent upon reading and understanding the present specification.

### DETAILED DESCRIPTION OF THE PREFERRED EMBODIMENTS

The present invention comprises processes for manufacturing, or preparing, a soy-based, reduced-calorie, fruit and/or vegetable spread product including whole, natural fruits or vegetables, or combinations thereof. According to a first preferred embodiment of the present invention, the processes include a plurality of steps. First, a source of soy protein, a portion of the total quantity of whole fruit(s) and/or vegetable(s) in the food product (or a combination thereof), a substance containing soluble dietary fiber, or, optionally a fortified dietary fiber, and pectin are combined and mixed to form a slurry. Then, the remaining portion of the total quantity of whole fruit(s) and/or vegetable(s) (or a combination thereof) and liquid sweetener are combined with the slurry to form a resulting mixture, or blend, which is subsequently mixed to a substantially even consistency. Finally, the resulting mixture is pasteurized and packaged in product form.

Described in more detail, the first step of the first preferred embodiment of the present invention comprises preparing a puree of a soy substance, preferably a tofu puree, and combining the soy with a portion of the overall amount of whole fruit(s) and/or vegetable(s), or a combination thereof, which are in the final product. The soy-fruit and/or vegetable mixture is combined with a dietary fiber component, and pectin. Additional ingredients such as glycerol or propylene glycol, starches, gelatin and water, for example and not limitation, may optionally be added, in accordance with alternate embodiments, to the soy, whole fruit(s) and/or vegetable(s), dietary fiber, and pectin. The combined ingredients are then, preferably, mixed with a mixer at high speed, which would be ascertainable to one of ordinary skill in the art, and at room temperature for a period of time sufficient to form a slurry or emulsion. A mixer, acceptable in accordance with the first preferred embodiment, is a high shear liquid mixer such as, for example and not limitation, a multiverter, available from Breddo Likwifier (a division of American Ingredients) or from Greerco High Shear Mixers (a division of Chemineer Co.). It is understood that the scope of the present invention includes the use of other types of mixers or multiverters available from other vendors and the use of other mixing methods. It is also understood that, in accordance with alternate embodiments of the processes, other ingredients may, optionally, be added to the slurry to provide variations in flavor, color, mouth feel and/or texture. Such other additional ingredients include, for example and not limitation, spices, acidifying agents, antioxidants, isoflavins, soy proteins, natural flavors and colors, buffering agents, preservatives, antifoaming agents and nutritive carbohydrate sweeteners. The mixed ingredients and any additional ingredients are then emulsified using a homogenizer, such as a Gaulin & Rannie (Invensys APV, New York). It is understood that the scope of the present invention includes the use of other types of homogenizers and emulsifiers available from other vendors and the use of other homogenizing or emulsifying methods.

Proceeding in accordance with the first preferred embodiment, the emulsified slurry is combined with the remaining whole fruit(s), vegetable(s), or combination thereof (i.e., of the total quantity of fruit(s) and/or vegetable(s) of the final product) to impart flavor and with a liquid sweetener. The emulsified slurry, fruit(s) and/or vegetable(s), and liquid sweetener are then blended in a blender for a period of time appropriate to produce a mixture, or blend, having an even and desired consistency. During combination and mixing, the temperature of the mixture, or blend, is kept at or below room temperature until the blend is transferred to a first swept-surface heat exchanger. Once the mixture, or blend, has been mixed to an even consistency and transferred to the first heat exchanger, the mixture is pasteurized by raising and holding the temperature of the blend, preferably, at a temperature in the range of 165° F. (74° C.) to about 225° F. (108° C.) for a period of time (i.e., “hold time”) between 10 seconds and 3 minutes, thereby killing any microbes that may be present in the blend. The required temperature and hold time are determined by the types of soy proteins, fruit(s) and/or vegetable(s) being used in the food product and, for certain fruit(s) and/or vegetable(s), respective temperatures and hold times of 95° C. and 100 seconds are appropriate. Generally, higher temperatures are combined with shorter residence times to provide satisfactory pasteurization.

According to the first preferred embodiment of the present invention, the pasteurization of the blend is performed in a first swept-surface heat exchanger having one or more cylinders of a particular size by pumping, or passing, the blend therethrough. The precise number and size of the cylinders is, generally, based upon the capacity and throughput desired for the process. A swept-surface heat exchanger, acceptable in accordance with the first preferred embodiment, includes a single cylinder, six inches in diameter by six feet in length. An acceptable swept-surface heat exchanger also includes a jacket through which a heat exchange medium such as low pressure steam or hot water passes to cause heating of the blend in the cylinder. The precise length of the cylinder, or holding tube, is based on the particular spread product and the combination of temperature and associated residence time needed to effect pasteurization. Such swept-surface heat exchangers are commonly found in the food industry and are available from vendors such as APV, Cherry Burrel, and Alpha-Laval. It is understood that the scope of the present invention includes the use of other temperatures, hold times, forms of equipment, and methods for pasteurizing the blend.

After pasteurization of the blend, the resulting soy-based fruit and/or vegetable product (e.g., a fruit and/or vegetable spread), is then partially cooled to a temperature in the range of 45° F. to about 165° F. Preferably, the partial cooling of the blend is accomplished by pumping, or passing, the blend through a second swept-surface heat exchanger which is substantially similar to the first swept-surface heat exchanger employed, as described above, to pasteurize the blend. However, in order to cool the blend, the heat exchange medium, preferably, includes, but is not limited to, cold water, sweet water, or a refrigerant.

Optionally, after the blend has cooled, it is transferred to a whipping machine such as, for example, APV Whipper/Chiller. It is understood that the scope of the present invention includes the use of other manufacturers, forms of equipment, and methods for aerating the blend. A final whipping stage is added to produce a lighter, aerated product, such as, for example and not limitation, whipped yogurts, mousse, creams, and the like.

Once the product is partially cooled, or chilled, and optionally aerated, the product is packaged, with the packaging being sealed immediately to minimize the exposure to air and, hence, to new microbes, spores, and other forms of possible contaminants. Preferably, the packaging includes squeezable tubes which are filled with the partially cooled blend through use of a tube filler. The tubes are then further chilled to refrigeration temperatures to protect against the breakdown of the soy-based fruit and/or vegetable product's texture, mouth feel, flavor, and color. It is important to note that, at lower blend temperatures, the packaging, or tube filling, should be performed in clean rooms to aid in preventing post-processing contamination. It is also important to note that the scope of the present invention includes other forms of packaging through use of other types of packaging equipment.

In accordance with a second preferred embodiment of the present invention substantially similar to the first preferred embodiment, a slurry is prepared from a soy protein source, preferably tofu puree, liquid sweetener, soluble dietary fiber, pectin, and all other optional ingredients described herein. The slurry is homogenized in a homogenizer, then combined and mixed with the flavor-imparting whole fruit(s), vegetable(s), or combination thereof, to form a blend. After combination and mixing, the blend is pasteurized, optionally aerated, and packaged using a method substantially like that of the first preferred embodiment.

In accordance with a third preferred embodiment of the present invention, substantially similar to the first preferred embodiment, the soluble dietary fiber is fortified with additional nutrients, including but not limited to vitamins, minerals, prebiotics, and probiotics, to create a nutritionally-fortified fruit and/or vegetable food product. In this third embodiment of the present invention, a soy protein source, preferably tofu puree, liquid sweetener, fortified soluble dietary fiber, pectin, starch and other optional ingredients described herein are combined in a multiverter as described above. The resulting slurry is homogenized in a homogenizer, then combined and mixed with the remaining flavor-imparting whole fruit(s), vegetable(s), or combination thereof, to form a blend. After combination and mixing, the blend is pasteurized, optionally aerated, and packaged using a method substantially like that of the first preferred embodiment.

In accordance with a fourth preferred embodiment of the present invention substantially similar to the first preferred embodiment, the soluble dietary fiber is fortified with additional nutrients, including but not limited to vitamins, minerals, prebiotics, and probiotics, to create a nutritionally-fortified fruit and/or vegetable food product. In this fourth embodiment of the present invention, a slurry is prepared from a soy protein source, preferably tofu puree, liquid sweetener, fortified soluble dietary fiber, pectin, and the other optional ingredients described herein. The slurry is homogenized in a homogenizer, then combined and mixed with the flavor-imparting whole fruit(s), vegetable(s), or combination thereof, to form a blend. After combination and mixing, the blend is pasteurized, optionally aerated, and packaged using a method substantially like that of the first preferred embodiment.

The term “sweetener,” as used herein, includes any substance capable of imparting sweetness to a product. Examples of contemplated sweeteners include, but are not limited to, fruit juice concentrate, white sugar, raw sugar, fructose, dextrose, fruit juices, corn syrup, artificial sweeteners, including aspartame, sucralose, acesulfame and saccharine, stevia, licorice root, rice syrup, honey, sugar alcohols or any combination thereof. In accordance with the preferred embodiments of the present invention, the amount of sweetener added during processing is between about 5 percent to about 50 percent, by weight, of the soy-based fruit and/or vegetable product. The amount of sweetener used, in proportion to the other ingredients, varies according to the particular fruit(s), vegetable(s), or combination of fruit(s) and vegetable(s) used in the product.

As used herein, the terms “dietary fiber” and “fiber” include any carbohydrate capable of providing bulking properties to the soy-based fruit and/or vegetable product, including, but not limited to, inulin and other plant starches and fructo-oligosaccharides. Inulin is a term applied to a water soluble, heterogeneous blend of fructose polymers found widely distributed in nature as plant storage carbohydrates. Oligofructose is a sub-group of inulin consisting of polymers with a degree of polymerization (DP) of 10 or less. Oligofructoses, acceptable in accordance with the preferred embodiments, include, but are not limited to, the beta-2,1 type, inulin, irisin and lycorisin. Preferably, the dietary fiber is inulin. Also preferably, the soy-based fruit and/or vegetable product includes dietary fiber present in an amount between about 0.5 percent and about 5 percent, by weight, of the final product. The precise amount of dietary fiber used, in proportion to the other ingredients, varies according to the particular fruit(s), vegetable(s), or combination thereof which are used in the product.

As used herein, the terms “fortified dietary fiber” and “fortified fiber” include any dietary fiber described above, wherein the dietary fiber is used to bind additional nutrients, such as vitamins, minerals, and pre- or probiotics. Preferably, the fortified dietary fiber is inulin, fortified with vitamins A, C, E and D and with calcium. Also preferably, the soy-based fruit and/or vegetable product includes fortified dietary fiber present in an amount between about 0.025 percent and about 5 percent, by weight, of the final product. The vitamins and minerals and other nutrients are preferably present in the fortified fiber in an amount between about 10% and 100% of the U.S. Recommended Daily Allowance (RDA). More preferably, the vitamins, minerals and other nutrients are present in the fortified fiber in an amount between about 25% and 50% RDA. The precise amount of fortified dietary fiber used, in proportion to the other ingredients, varies according to the particular fruit(s), vegetable(s), or combination thereof which are used in the product.

As used herein, the terms “soy,” “soy protein,” or “soy protein source” refer to any substance derived from soybeans which imparts at least 5% by weight of protein to the product. Preferably, the substance imparts between 20-30% by weight of protein to the product. Examples of soy or soy protein include, for example and not limitation, tofu, tofu puree, soy isolates, soy concentrates, textured soy protein, soy beans, soy nuts, miso, natto, tempeh, soy sauce, soy milk, soy flour, ground soy, ground soy beans, isolated soy protein, soy flakes, soybean oil, lecithin, and soy germ. The soy protein may be in any form, including, for example and not limitation, powder, puree, paste, liquid or solid. Soy used in the processes of the present invention may be commercially available or prepared prior to mixing with the ingredients of the present invention. Since commercially available soy products are usually pasteurized, the soy present in the final product of the present invention is twice pasteurized. A preferred soy protein for use in the processes of the present invention is tofu puree.

The term, “pectin,” as used herein, refers to any substance forming a colloidal solution in water which gels upon cooling. The pectin may be in powder or liquid form, naturally occurring or modified. According to the preferred embodiments of the present invention, the soy-based fruit and/or vegetable product includes pectin in an amount between about 0.5 percent to about 3 percent, by weight, of the final product. The amount of pectin used, in proportion to the other ingredients, varies according to the particular fruit(s), vegetable(s), or combination thereof present in the product. Notably, the pectin is uncooked in the processes of the present invention, thereby causing less breakdown of the pectin than would likely otherwise occur if the pectin was cooked.

As used herein, the term “fruit” includes any commonly-known fruit having a desired flavor, including, but not limited to, berries, including but not limited to apples, oranges, peaches, pears, pineapples, kiwis, apricots, plums, grapes, cherries, mangos, melons, strawberries, blackberries, blueberries, raspberries, boysenberries, marion berries, mulberries, and the like.

The term “vegetable”, as used herein, includes any commonly-known vegetable having a desired flavor, including, but not limited to, tomatoes, carrots, hicma, beets, squash, spinach, onions, garlic, peppers (i.e., including jalapeno peppers), avocados, and herbs.

The terms “whole fruit,” “whole vegetable,” or “whole” in relation to fruits and/or vegetables, as used herein refers to fruits or vegetables, as defined above, which are present in solid form and not in pulverized or pureed form. The term includes, without limitation, chunks, slices, pieces and other forms of solid fruit or vegetable, as well as the fruit or vegetable in its unprocessed form.

As used herein, the terms “fruit spread”, “fruit spread product”, “vegetable spread”, “vegetable spread product,” “fruit food product,” and “vegetable food product” include, but are not limited to, jams, jellies, preserves, purees, marmalades, beverages, snacks, pie fillings, puddings, and bases for: fruit-flavored drinks and/or beverages, such as “smoothies,” ice cream toppings, condiments, fruit toppings, yogurts, dressings, baby food, curd, cheeses, dips, and sauces.

As used herein, the terms “nutritional ingredients,” “nutrients” and “supplemental nutrients” includes, by example and without limitation, vitamins, minerals, fiber, herbs or other botanicals, amino acids, substances such as enzymes, metabolites, and pre- and probiotics.

As used herein, the term “vitamins” includes, without limitation, any organic substance necessary to metabolize food in animals. Specifically contemplated vitamins include, but are not limited to, vitamin A, vitamin D, vitamin E, vitamin K, vitamin C, thiamine, riboflavin, niacin, vitamin B₆, folate, and vitamin B₁₂.

The term “minerals,” as used herein, includes, by example and without limitation, calcium, phosphorus, magnesium, iron, zinc, iodine, and selenium.

The term “herbs or other botanicals,” as used herein, includes processed or unprocessed plant parts (bark, leaves, flowers, fruits, and stems) as well as extracts and essential oils. They are available as teas, powders, tablets, capsules, and elixirs. Examples of herbs and botanicals include, by example and without limitation, DHEA, ginger, ginkgo biloba, ginseng, melatonin, saw palmetto, St. John's wort, milk thistle, aloe, Echinacea, and garlic, among others.

As used herein, the term “amino acids” is defined as the building blocks of proteins and the precursors of various nitrogen-containing molecules in the body. The term includes the amino acid, itself, as well as derivatives thereof. Examples of amino acids and their derivatives include, by example and without limitation, histidine, isoleucine, leucine, lysine, methionine, phenylalanine, threonine, tryptophan, valine, alanine, arginine, asparagine, aspartic acid, citrulline, cysteine, cystine, gamma-aminobutyric acid, glutamic acid, glutamine, glycine, ornithine, proline, serine, taurine and tyrosine.

As used herein, the term “probiotic” is defined as any substance or micro-organism which promotes the growth of other micro-organisms in the human body and results in a beneficial effect on the body. Examples of probiotics include, as example and without limitation, bacteria strains of Lactobacillus and Bifidobacterium, including Lactobacillusjohnsonii (La1), Bifidobacterium lactis (BL), Sporogene, Lactobacillus Acidophilus, Lactobacillus Delbruekeii, Lactobacillus Caseii, Lactobacillus Bulgaricus, Lactobacillus Causasicus, Lactobacillus Fermenti, Lactobacillus Plantarum, Lactobacillus Brevis, Lactobacillus Heleveticus, Lactobacillus Leichmannii, Lactobacillus Lactis, Lactobacillus Bifidus, Saccharomyces boulardii, Lactobacillus rhamnosus GG, Bifidobacterium bifidum and Streptococcus thermophilus, among others.

As used herein, the term “prebiotic” is defined as any non-digestible food ingredient that beneficially affects the host by selectively stimulating the growth and/or activity of one or a limited number of bacteria in the colon to improve host health. Prebiotics include, by example and not by limitation, Fructooligosaccharides (FOS), inulin, galactooligosaccharides and other digestion resistant carbohydrates or oligosaccharides, pyrodextrins, maltodextrins, soybean oligosaccharides (raffinose, stachyose), lactulose, isomalto-oligosaccharides, lactosucrose, gluco-oligosaccharides, palatinose, tagatose, and lactitol.

As used herein, the terms “starch” or “modified starch” refer to any food-grade carbohydrate. Preferred starches include, but are not limited to, potato starch, rice starch, corn starch, or vegetable starch.

As used herein, the term “non-hydrogenated oil” refers to an unsaturated fat, including monounsaturated fats and polyunsaturated fats. Examples of non-hydrogenated oils include, for example and not limitation, coconut oil, canola oil, olive oil, sunflower oil, sesame oil, rapeseed oil, soybean oil, corn oil, safflower oil, cottonseed oil and peanut oil.

The following examples are merely illustrative of the processes and resulting products of the present invention and do not serve to limit the invention thereto.

### EXAMPLE 1

### Soy-Based Fruit Spread

In accordance with the preferred embodiments of the present invention, the following ingredients, by weight, are combined and mixed together at room temperature using a Gaulin & Rannie homogenizer and a Groen scraped-surface mixer to form a slurry:

0-75% wt. Fruit or vegetable or combination (whole, diced, chunky or puree)

0-55% wt. Tofu puree

0-50% wt. Sweetener

0-5% wt. Modified Starch

0-20% Water

0-6% wt. Soluble fiber or fortified soluble fiber

0-2% wt Non-hydrogenated oil

0-5% wt. Natural or artificial flavors

0-5% wt. Natural or artificial colors

Tofu puree is combined with all or a portion of the fruit, water, sweetener, soluble fiber, or optionally fortified soluble fiber, and modified starch. The ingredients are combined in a multiverter until they achieve an even consistency, then transferred to a Gaulin & Rannie homogenizer for emulsification. The emulsified mixture is blended with any remaining fruit and is pumped into a first swept surface heat exchange cylinder and heated to a temperature between 165° F. and 225° F. for ten seconds to three minutes. The heated product is transferred to a second swept surface heat exchange where the temperature is lowered to between 45° F. and 165° F. The cooled product is passed through an APV Whipper, which aerates the product. Once the product is aerated, it is packaged by any filling process known in the art.

### EXAMPLE 2

### Strawberry Soy Fruit Spread

30-75% wt. whole strawberries

5-55% wt. tofu puree

15-50% wt. white grape juice concentrate

0.05-5% wt. cornstarch

0.05-20% water

0.05-6% wt. inulin or fortified inulin

0.05-2% wt coconut oil

A slurry of tofu puree, cornstarch, white grape juice concentrate, inulin or fortified inulin, and coconut oil is prepared and mixed in a multiverter. The slurry is emulsified in a Gaulin & Rannie homogenizer. The emulsified slurry is combined with about 55-70% whole strawberries until the mixture, or blend, has an even consistency. The mixture is then pumped through a swept-surface heat exchanger, where the mixture is heated to and held at a temperature of between 180° F. to 225° F. for a period of about twenty seconds to three minutes. Next, the mixture is passed through a second swept-surface heat exchanger to partially cool the mixture to a temperature of between 45° F. to 155° F. Finally, the partially cooled mixture is aerated in an APV whipper and packaged in squeeze tube packages.

### EXAMPLE 3

### Raspberry Smoothie Flavoring

The following ingredients are, according to the preferred embodiments of the present invention, mixed together at room temperature using a Breddo Likwifier mixer and a Groen swept-surface mixer to form a homogenized slurry:

1-5% low-ester citrus pectin

10-40% tofu puree

1-3% inulin or fortified inulin

15-35% white grape juice concentrate with a Brix level of 68

15-35% organic liquid sugar with a Brix level of 72

40-65% whole raspberries

Once the slurry, or emulsion, is formed, the mixture is pumped through a swept-surface heat exchanger and heated to and held at a temperature of between 180° F. to 225° F. for a period of about one to three minutes. Next, the mixture is passed through a second swept-surface heat exchanger to partially cool the mixture to a temperature of between 45° F. and 165° F. Finally, the partially cooled mixture was aerated with an APV Whipper and packaged in appropriate packaging.

Whereas this invention has been described in detail with particular reference to its most preferred embodiments, it is understood that variations and modifications can be effected within the spirit and scope of the invention, as described herein before and as defined in the appended claims. The corresponding structures, materials, acts, and equivalents of all means plus function elements, if any, in the claims below are intended to include any structure, material, or acts for performing the functions in combination with other claimed elements as specifically claimed.

What is claimed is:

1. A process for preparing a soy-based fruit or vegetable product comprising the steps of:
(a) mixing and homogenizing, a tofu puree, a sweetener, a soluble dietary fiber, and pectin for a period of time sufficient to form a slurry;
(b) adding whole fruit and/or vegetables to the slurry;
(c) pasteurizing the mixture of fruit and/or vegetable and slurry resulting from step (b);
(d) cooling the mixture of fruit and/or vegetable and slurry; and
(e) aerating the mixture.

2. A process for preparing a soy-based fruit or vegetable product comprising the steps of:
(a) mixing and homogenizing fruit and/or vegetables, a tofu puree, a sweetener, a soluble dietary fiber, and pectin for a period of time sufficient to form a slurry;
(b) adding additional fruit and/or vegetables to the slurry;
(c) pasteurizing the mixture of fruit and/or vegetable and slurry resulting from step (b);
(d) cooling the mixture of fruit and/or vegetable and slurry; and
(e) aerating the mixture.
